(19) United States
(12) Patent Application Publication
(10) Pub. No.: US 2015/0009100 A1
(43) Pub. Date: Jan. 8, 2015

(54) PROJECTION TYPE IMAGE DISPLAY DEVICE

(71) Applicant: DENSO CORPORATION, Kariya-city (JP)

(72) Inventors: Narihiro HANEDA, Nagoya-city (JP); Makoto SAKAI, Kitanagoya-city (JP)

(21) Appl. No.: 14/312,846

(22) Filed: Jun. 24, 2014

(30) Foreign Application Priority Data
Jul. 2, 2013 (JP) 2013-138776
Jul. 2, 2013 (JP) 2013-138777

(51) Int. Cl. B60R 1/00

(52) U.S. Cl. CPC B60R 1/00; B60R 2300/205
USPC 345/7

(57) ABSTRACT

A projection type image display device includes a processor having a measuring part for performing a three-dimensional measurement of an A-pillar and a projection range controller for controlling a projection range of an image light, which is matched to an A-pillar surface based on a result of the three-dimensional measurement. Thus, the projection of an image onto the A-pillar surface by the projection type image display device is easily performed regardless of whether the A-pillar surface is a two-dimensional flat surface or a three-dimensional surface. The projection type image display device also directs a retro-reflective component in a reflected image light away from a driver's seat based on a positioning of an image projection device. Speckled uneven image brightness on an image display surface is thereby prevented.

### CROSS REFERENCE TO RELATED APPLICATION

The present application is based on and claims the benefit of priority of Japanese Patent Applications No. 2013-138776 and No. 2013-138777, both filed on Jul. 2, 2013, the disclosures of which are incorporated herein by reference.

### TECHNICAL FIELD

The present disclosure generally relates to a projection type image display device for displaying an image by projecting light onto an object surface of a vehicle compartment.

### BACKGROUND INFORMATION

A patent document 1 (i.e., Japanese Patent No. 3761550) discloses a projection type image display device which displays an image by projecting light onto an object surface. In patent document 1, the projection type image display device displays the image by projecting light onto the object surface or onto a projection face. The projection type image display device further includes a light intensity sensor for measuring the intensity of a reflected light by receiving the reflected light that is reflected by the projection face. This projection type image display device calculates a positional relationship between the projection type image display device and the projection face based on the intensity of the reflected light received by the light intensity sensor.

In the above-mentioned patent document 1, the image display surface or the projection face on which the projection type image display device displays an image is a plane or flat surface. However, when displaying the image, the projection type image display device may not only project the light onto a two-dimensional flat surface but also onto a three-dimensional surface (e.g., a convex/concave-type surface). More specifically, the projection type image display device which projects light onto the three-dimensional surface for the display of the image cannot grasp the physical relationship between the projection type image display device and the image display surface even when the intensity of the reflected light is measured by the light intensity sensor of the patent document 1. That is, the projection type image display device of the patent document 1 is suitable only for displaying an image on the two-dimensional flat surface, and is not suitable for displaying an image on the three-dimensional surface.

A patent document 2 (i.e., Japanese Patent No. 4280648) discloses a projection type image display device for vehicles which displays an image by projecting an image light on an image display surface that is disposed in a vehicle compartment. More specifically, the projection type image display device of patent document 2 displays an image on a surface of an A-pillar (i.e., a front pillar) in the vehicle compartment. That is, the image display surface of the present device is an A-pillar surface or a front pillar surface.

In the above-mentioned patent document 2, the image display surface is the surface of the front pillar and the surface of the front pillar has a three-dimensional shape. Therefore, if a light reflection characteristic is the same at all parts of the surface, brightness of the image at different parts that is observed by a viewer of the image (i.e., a driver of the vehicle) may be uneven due to the three-dimensional shape of the surface. That is, the image may have a speckle pattern. The speckle pattern may appear uneven in brightness and the displayed image may deteriorate the driver's comfort in the vehicle.

### SUMMARY

It is an object of the present disclosure to provide a projection type image display device for displaying an image having even brightness and in a target range having two- or three-dimensional image display surfaces.

In an aspect of the present disclosure, the projection type image display device of the present disclosure includes an image projection device that projects a measurement light onto a target object to provide a three-dimensional measurement of the target object and projecting an image light onto an object surface of the target object to display an image onto the object surface. The projection type image display device also includes a measuring part that performs the three-dimensional measurement of the target object by using the measurement light, and a projection range controller that controls a projection range of the image light to match the projection range with the object surface based on a result of the three-dimensional measurement.

According to the present disclosure, the image is displayed on the object surface regardless of whether the object surface of the target object is a two-dimensional flat surface or a three-dimensional surface, since the projection range controller controls the projection range of the image light for a matching of the image light with the object surface based on the result of the three-dimensional measurement.

In another aspect of the present disclosure, the projection type image display device for vehicles concerning the present disclosure for achieving the above-mentioned purpose includes an image projection device (18) that projects an image light (RYpj), and an image display surface that is disposed on a vehicle compartment side of a front pillar (12) on a driver's seat (11R) side of a windshield (26) and displaying an image by reflecting the image light. The image display surface (121) includes a first area (121a) and a second area (121b) each having normal lines pointing in different directions, the first area reflecting the image light both in a retro-reflective manner and in a diffusive manner and the second area reflecting the image light in the diffusive manner. A normal line (LVa) of the first area points in a direction that is closer to a driver's seat than does a normal line (LVb) of the second area. A ratio of a retro-reflective component in the reflected image light from the first area is greater than a ratio of a retro-reflective component in the reflected image light from the second area. A ratio of a diffusive component of the reflected image light from the first area is smaller than a ratio of a diffusive component of the reflected image light from the second area. The image projection device controls the retro-reflective components in the reflected image light from the first and second areas to direct the retro-reflective components away from the driver's seat.

In the above-described configuration, the first area with the normal line pointing closer to the driver's seat in comparison to the second area indicates that the first area of the image display surface is more normally-facing toward the driver sitting in the driver's seat than the second area. Therefore, in case that each of the first area and the second area reflects the image light only in the diffusive manner without reflecting the image light in the retro-reflective manner, the displayed image on the first area should look brighter than the displayed image on the second area.

However, according to the above-described disclosure, the image projection device is arranged to control the retro-reflective components of the reflected image light from the first and second areas respectively to direct them away from the driver's seat. Therefore, the diffusive component of the reflected image light and not the retro-reflective component of the reflected image light enter into the driver's eye and are thus recognized by the driver. Further, a ratio of the retro-reflective component in the reflected image light from the first area is greater than a ratio of the retro-reflective component in the reflected image light from the second area, and a ratio of the diffusive component in the reflected image light from the first area is smaller than a ratio of the diffusive component in the reflected image light from the second area. Therefore, in the driver's view, a brightness difference between the reflected image light from the first area and the reflected image light from the second area is reduced (i.e., is less recognizable). As a result, unevenness of the brightness of the reflected image light that is unevenly speckled among the first area and the second area is prevented. That is, uneven brightness of the two areas is prevented.

Note that each of the numerals in parentheses in the above and in the claims shows a relationship between a part/component in the summary and a part/component in the embodiment.

### BRIEF DESCRIPTION OF THE DRAWINGS

Objects, features, and advantages of the present disclosure will become more apparent from the following detailed description made with reference to the accompanying drawings, in which:

FIG. 1 is an illustrated configuration of a projection type image display device inside of a vehicle compartment in a first embodiment of the present disclosure;

FIG. 2 is a block diagram of the configuration of the image projection device in FIG. 1;

FIG. 3 is an illustration of a scanning of a measurement light that is used in a three-dimensional measurement performed by the projection type image display device in FIG. 1;

FIG. 4 is an illustrated configuration of the projection type image display device inside of a vehicle compartment in a second embodiment of the present disclosure;

FIG. 5 is an illustration of the image projection device in FIG. 4 which is attached on a ceiling of the vehicle compartment;

FIG. 6 is a block diagram of the configuration of the image projection device that is modified from the configuration in FIG. 2;

FIG. 7 is an illustrated configuration of the projection type image display device in a first modification that is modified from the configuration in FIG. 1;

FIG. 8 is an illustrated configuration of the projection type image display device in a second modification that is modified from the configuration in FIG. 1;

FIG. 9 is an illustration of a configuration of a projection type image display device inside of the vehicle compartment in a third embodiment of the present disclosure;

FIG. 10 is a sectional view of a surface of an A-pillar in FIG. 9 along a thickness direction of the surface;

FIG. 11 is an illustration of a relationship between a driver, an image projection device, and the surface of the A-pillar in the vehicle compartment of FIG. 9;

FIG. 12 is an illustration of a first modification of the configuration in FIG. 9; and

FIG. 13 is an illustration of a second modification of the configuration in FIG. 9.

### DETAILED DESCRIPTION

Hereafter, the embodiment of the present disclosure is described based on the drawings. In each of the following embodiments, the same numerals are assigned to the same/equivalent components in the drawings.

### First Embodiment

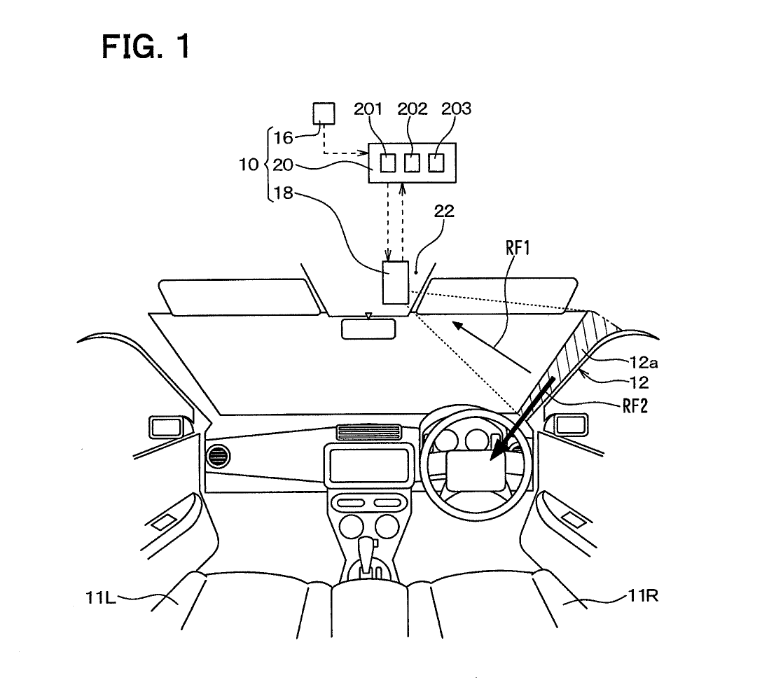

FIG. 1 shows an illustrated configuration of a projection type image display device 10 in the first embodiment, together with a front view from an inside of a vehicle compartment in the first embodiment of the present disclosure. This projection type image display device 10 is a display device for vehicles, and it is used, for example, to perform an optical camouflage in a vehicle compartment. More specifically, the projection type image display device 10 may be used to optically eliminate a dead angle (i.e., causing a blind spot) in a view of a driver, which is caused by an A-pillar 12 disposed on a driver's side of a windshield (i.e., on a driver's seat 11R side), by projecting an outside view image onto an inside surface 12a of the A-pillar 12, i.e., onto an A-pillar surface 12a outside view image projected thereon is thus taken as a matching image of a dead angle caused by the A-pillar 12 in a view of the driver. The front pillar 12, i.e., the A-pillar 12, corresponds to a target object in the claims of the present disclosure, and the A-pillar surface 12a corresponds to an object surface in the present disclosure.

The projection type image display device 10 shown in FIG. 1 includes a camera 16 for imaging an outside view of the vehicle in the dead angle of the driver by the A-pillar 12, and an image projection device 18 that serves as a projector for projecting an image light onto the A-pillar surface 12a, and a processing device 20 which is an electrical control unit disposed at a position that is not visible from a vehicle occupant.

The camera 16 for imaging the outside view is a CCD camera, for example. The camera 16 for imaging the outside view is disposed so that the outside view from the camera 16 is substantially the same as the view of the driver who is sitting on the driver's seat 11R, i.e., a dead angle image of the outside view behind the A-pillar 12. That is, the driver's view and the view of the camera 16 are substantially the same, in terms of the view around the A-pillar 12 (i.e., both views point to the same direction, for example). The camera 16 for imaging the outside view is attached on an outside of the vehicle in proximity of the A-pillar 12.

The image projection device 18 is a laser projector which projects a laser beam and displays an image. The image projection device 18 is disposed at a forward center position on a vehicle compartment ceiling 22, for projecting the laser beam toward the A-pillar 12.

More concretely, the image projection device 18 projects the laser beam as the image light, in order to display the image captured by the camera 16 on the A-pillar surface 12a. That is, a dead angle image which comprises an outside view of the vehicle in a dead angle of the A-pillar 12 relative to the driver in the driver's seat 11R is captured by the camera 16 at predetermined intervals or continuously, and the captured image, i.e., the dead angle image, is then projected by the image projection device 18 as the image light, and is displayed on the A-pillar surface 12a.

Further, the image projection device 18 projects the laser beam as a measurement light onto the A-pillar 12 for the three-dimensional measurement of the A-pillar 12. Then, the image projection device 18 receives a reflected light which is a reflection of the measurement light projected by the image projection device 18 reflected by the A-pillar 12.

Further, the A-pillar surface 12a is provided with both of a retro-reflective characteristic and a diffuse-reflective characteristic so that (i) the reflected image light reflected by the A-pillar surface 12a reaches a driver's eye having a sufficient light quantity and (ii) the reflection of the measurement light from the image projection device 18 returns to the device 18 having a sufficient light quantity for enabling the three-dimensional measurement. Such reflective characteristics of the A-pillar surface 12a may be constituted, for example, by providing the A-pillar surface 12a with the diffuse-reflective characteristic, on which a thin film layer of the retro-reflective characteristic is coated, which may be made of glass beads or the like. In FIG. 1, an arrow RF1 represents a retro-reflected component of the image light and the measurement light, and an arrow RF2 represents a reflected component which goes into the driver's eye.

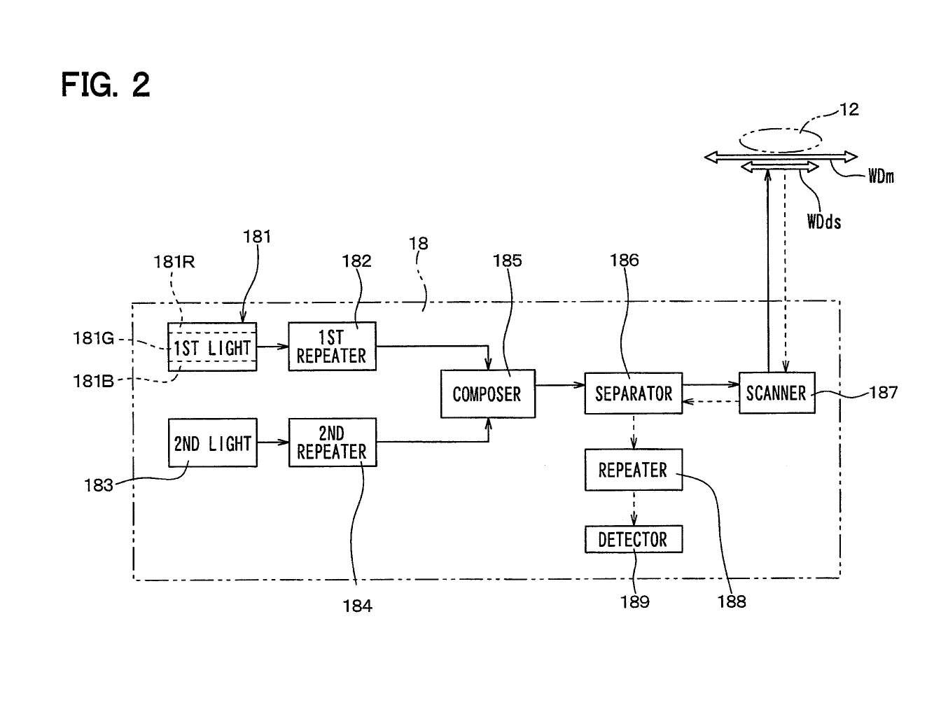

Here, the configuration of the image projection device 18 is described in detail with reference to FIG. 2. FIG. 2 is a block diagram which shows an exemplary configuration of the image projection device 18. In FIG. 2, a path of the light projected by the image projection device 18 is shown by a solid line arrow, and a path of the light received by the image projection device 18 is shown by a dashed line arrow.

As shown in FIG. 2, the image projection device 18 is provided with a first light source 181, a first repeater 182, a second light source 183, a second repeater 184, a composer 185, a light separator 186, a light scanner 187, a receiver repeater 188, and a receiver detector 189.

The first light source 181 is a laser light source which outputs the image light which is a visible light, for example. The first light source 181 may be comprised of a semiconductor laser diode or a gas laser, for example.

Concretely, the first light source 181 is provided with a red laser light source 181R which outputs a red laser beam which is one of the three primary colors of light, a green laser light source 181G which outputs a green laser beam, and a blue laser light source 181B which outputs a blue laser beam. The first light source 181 outputs the image light which is a composition of three color laser beams from the laser light sources 181R, 181G, and 181B.

The first repeater 182 is disposed in a path of the image light which leads to the composer 185 from the first light source 181. The first repeater 182 is provided with a lens and the like, for preventing a diffusion of the image light projected by the first light source 181, and for guiding the image light into the composer 185.

The second light source 183 is a laser light source which outputs the measurement light, which may be a monochromatic visible light, for example. That is, the measurement light is a laser beam. The second light source 183 may be comprised of a semiconductor laser diode or a gas laser, for example.

The second repeater 184 is disposed in a path of the measurement light which leads to the composer 185 from the second light source 183. The second repeater 184 is provided with a lens and the like, for preventing a diffusion of the measurement light projected by the second light source 183, and for guiding the measurement light into the composer 185.

The composer 185 guides both of the image light from the first repeater 182 and the measurement light from the second repeater 184 into one light path that leads to the light separator 186 from the composer 185. The composer 185 may be comprised of a dichroic mirror with a film, a dichroic prism with a film, a diffractive optical element (DOE) or a holographic optical element (HOE), for example.

The light separator 186 is disposed in a light path which leads to the light scanner 187 from the composer 185. The light separator 186 projects the light from the light scanner 187, i.e., the reflected light, towards the receiver repeater 188 by refracting the light, while projecting, to the light scanner 187, the image light and the measurement light from the composer 185 as they are. The light separator 186 may be comprised of a prism with a dielectric multilayer, a metal wire grid, or the like, for example.

The light scanner 187 projects the image light and the measurement light, i.e., the laser beam, which come in from the light separator 186 in a scanning manner in two dimensions towards the A-pillar 12. That is, the laser beam is output towards the A-pillar 12. In FIG. 2, the A-pillar 12 is illustrated by a two-dot chain line. The light scanner 187 is provided with an optical system which transmits a laser beam, and an optical polariscope which scans a laser beam.

The optical polariscope may be, for example, provided with an X-axis galvanometer rotating an X-axis galvano-mirror for scanning the laser beam in an X axis direction, and a Y-axis galvanometer rotating a Y-axis galvano-mirror for scanning the laser beam in a Y axial direction, the X axis and the Y axis defining an orthogonal coordinate system. By regulating the rotation range of the X/Y-axis galvanometers, the scan range of the laser beam is controlled.

In FIG. 2, a measurement scan range for the three-dimensional measurement of the A-pillar 12 by scanning the measurement light is represented by an arrow WDm. Further, in FIG. 2, an imaging scan range for the display of the image on the A-pillar surface 12a by scanning the image light is represented by an arrow WDds. As shown in FIG. 2, the imaging scan range of the image light is set up to be included in the measurement scan range of the measurement light.

The receiver repeater 188 is disposed in a path of the reflected light which leads to the receiver detector 189 from the light separator 186. The receiver repeater 188 is provided with a lens and the like, for preventing a diffusion of the reflected light projected by the light separator 186, and for guiding the reflected light towards the receiver detector 189.

The receiver detector 189 receives the reflected light from the receiver repeater 188. The receiver detector 189 is a photodetector which detects the light intensity of the received light. The receiver detector 189 outputs a signal of the detected light intensity to the processing device 20 (refer to FIG. 1) at predetermined intervals.

Referring back to FIG. 1, in which the processing device 20 is an electrical control unit which is comprised of a microcomputer having CPU, ROM, RAM, etc. and a peripheral circuit of well-known parts. The processing device 20 performs various control processes according to a computer program memorized in advance in the ROM or the like.

Further, as shown in FIG. 1, an image signal which represents image information captured by the camera 16 and a signal of the light intensity from the receiver detector 189, together with other signals, are inputted at predetermined intervals into the processing device 20. The processing device 20 outputs, for example, an image control signal which controls the image light output from the first light source 181 of the image projection device 18, and a measurement control signal which controls the measurement light output from the second light source 183 of the image projection device 18 at predetermined intervals towards the image projection device 18.

The processing device 20 outputs, to the first light source 181, a signal which controls the first light source 181 to output the image light, and outputs, to the light scanner 187, a signal which controls the light scanner 187 to scan the image light, for displaying an image on the A-pillar surface 12a by the projection of the image light onto the A-pillar surface 12a. Further, the processing device 20 outputs, to the second light source 183, a signal which controls the second light source 183 to output the measurement light, and outputs, to the light scanner 187, a signal which controls the light scanner 187 to scan the measurement light, for the three-dimensional measurement of the A-pillar 12 by the projection of the measurement light onto the A-pillar 12. Therefore, the processing device 20 is provided with a measuring part 201 which performs the three-dimensional measurement, a projection range controller 202 which sets the projection range for projecting the image light, and an image controller 203 which displays an image on the A-pillar surface 12a by projecting the image light.

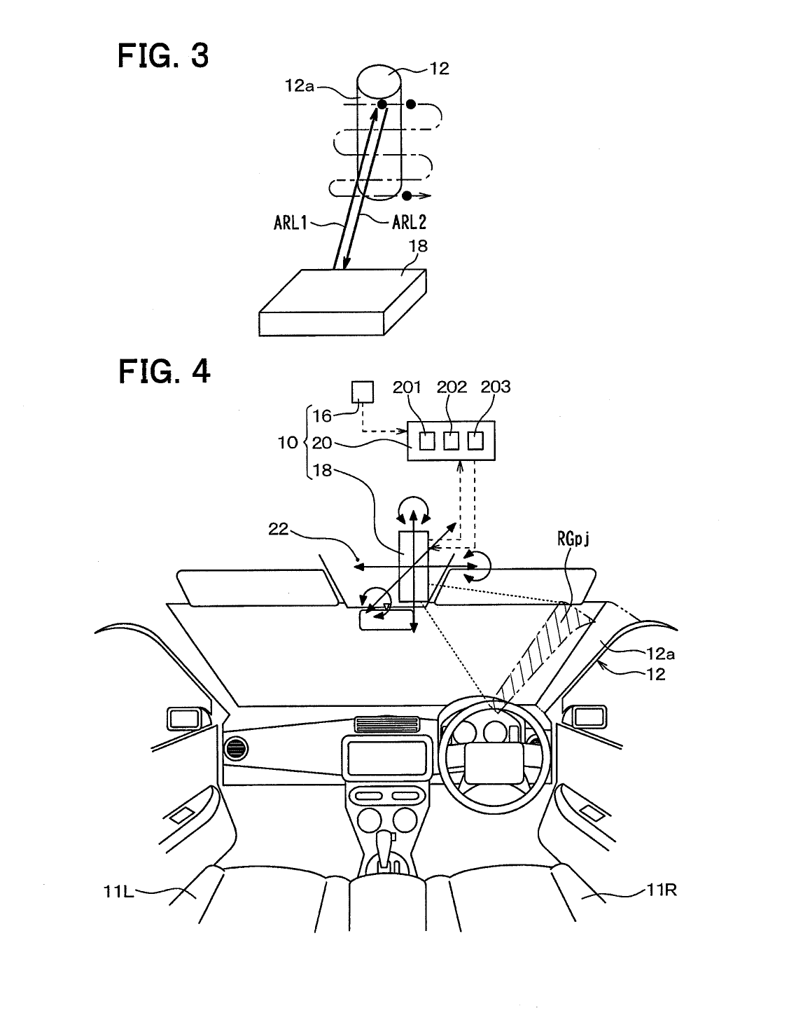

The measuring part 201 outputs, to the second light source 183, a signal which controls the second light source 183 to output the measurement light, and outputs, to the light scanner 187, a signal which controls the light scanner 187 to scan the measurement light, for two-dimensionally scanning the measurement light in the measurement scan range that is a predetermined range that is broader than the A-pillar surface 12a, as shown in FIG. 3 by a dashed dotted line arrow. That is, FIG. 3 is an illustration of a scanning of the measurement light for performing the three-dimensional measurement. An arrow ARL1 in FIG. 3 represents the measurement light projected by the image projection device 18, and an arrow ARL2 represents the reflected light of the measurement light reflected by the A-pillar surface 12a.

Further, the measuring part 201 in FIG. 1, besides scanning the measurement light, obtains a signal of the light intensity of the reflected from the receiver detector 189 at predetermined interval (refer to FIG. 2), and performs the three-dimensional measurement by using a well-known method in the measurement scan range based on the scanning direction of the measurement light and the light intensity of the reflected light, which are derived from the scanning by the light scanner 187.

The measuring part 201 specifically determines, after the three-dimensional measurement, an outline of the A-pillar surface 12a from a three-dimensional measurement shape obtained by the three-dimensional measurement by using a publicly-known method, and sets the outline as a display target range of the image in which the image by the image light is displayed. For example, for the determination of the outline of the A-pillar surface 12a measuring part 201 stores, in advance, three dimensional shape data of the A-pillar surface 12a as separate data of an object. In such manner, by finding a matching portion in the above-described three-dimensional measurement shape, the measuring part 201 determines the outline of the A-pillar surface 12a.

When the measuring part 201 sets the display target range, the projection range controller 202 obtains the display target range from the measuring part 201, and adjusts the projection range of the image light to the display target range. For example, the projection range controller 202 adjusts the projection range of the image light to the display target range by adjusting the rotation range of the X-axis galvanometer and the Y-axis galvanometer of the light scanner 187 (refer to FIG. 2) to a range that is more restricted than the three-dimensional measurement time.

When the projection range controller 202 adjusts the projection range of the image light to the display target range, the image controller 203 thereafter outputs, to the image projection device 18, the image control signal which controls the first light source 181 (refer to FIG. 2) to project the image light and which controls the light scanner 187 to scan the image light, when, for example, a switch operation of the driver instructs the display of the image. Upon receiving such an instruction, by controlling the image projection device 18 to project the image light, the dead angle image captured by the camera 16 for imaging the outside view is displayed on the A-pillar surface 12a which is set as the display target range.

Since a relative position relationship between the image projection device 18 and the A-pillar 12 will not change after manufacturing of the vehicle, the three-dimensional measurement mentioned above and the alignment of the projection range of the image light to the display target range need to be performed only once before a shipment of the vehicle, for example.

As mentioned above, according to the present embodiment, since the projection range controller 202 adjusts the projection range in which the image light is projected to the A-pillar surface 12a which is the display target range based on the result of the three-dimensional measurement of the A-pillar 12, the image can be easily displayed on the A-pillar surface 12a, without regard to whether the A-pillar surface 12a is a two-dimensional flat surface or a three-dimensional surface.

Further, since the display target range is set up for each of the vehicles based on the result of the three-dimensional measurement of the A-pillar 12 according to the present embodiment, even when the outline shape of the A-pillar 12 varies vehicle to vehicle, the variation of the outline shapes is absorbed based on the three-dimensional measurement and the image light is suitably projected onto the A-pillar surface 12a. Further, by absorbing the variation of the outline shapes of the A-pillar 12 in such manner for projecting the image light, a spill of the image light toward an outside of the vehicle is prevented, thereby enabling a prevention of dizziness of a pedestrian walking around the vehicle, for example.

Further, according to the present embodiment, the image projection device 18 has the first light source 181 that is a light source of the image light and also has the second light source 183 that is a separate light source of the measurement light separately provided besides the first light source 181, the wavelength of the measurement light is enabled to have a suitable wavelength for the three-dimensional measurement, without restricting or limiting the measurement light to the visible light.

### Second Embodiment

The second embodiment of the present disclosure is described in the following. The description of the present embodiment focuses on a different point from the above-mentioned first embodiment, and the same description as the first embodiment will not be repeated.

FIG. 4 shows an outline configuration of the projection type image display device 10 of the present embodiment, together with a front view from an inside of a vehicle compartment in the first embodiment of the present disclosure. In the first embodiment described above, the projection range of the image light from the image projection device 18 is adjusted to the display target range, not by changing the position and/or angle of the image projection device 18 relative to the ceiling 22, but by adjusting the rotation range of the X/Y-axis galvanometers in the image projection device 18.

On the other hand, in the present embodiment, a projection range RGpj of the image projection device 18 is adjusted to the display target range, i.e., to the A-pillar surface 12a by moving and rotating the image projection device 18 relative to the ceiling 22 based on a prefixed relative relationship between the image projection device 18 and the projection range RGpj as shown in FIG. 4. The projection range RGpj is prepared to have the same outline as the outline of the A-pillar surface 12a, as shown in FIG. 4.

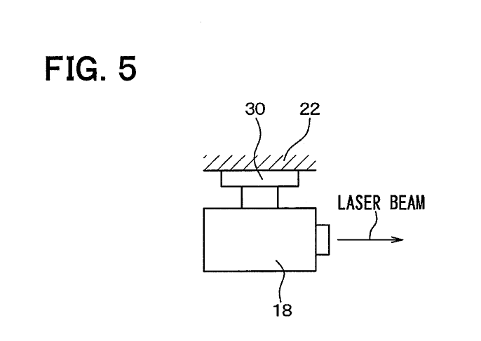

More concretely, the projection type image display device 10 is provided with a position adjustment mechanism 30 which changes the projection direction of the image light by adjusting a mounting angle/position of the image projection device 18 as shown in FIG. 5. The image projection device 18 is attached on the vehicle compartment ceiling 22 by using the position adjustment mechanism 30. FIG. 5 shows a mounting state of the image projection device 18 on the vehicle compartment ceiling 22.

The position adjustment mechanism 30 is provided with plural actuators, which allows the image projection device 18 to be movable along each of the three axial directions which intersect mutually perpendicularly as indicated by the arrows in FIG. 4 against the vehicle compartment ceiling 22 by the drive of the actuator, and also to be rotatable about each of the three axes. In such manner, the position adjustment mechanism 30 changes the direction of the laser beams, i.e., the image light and the measurement light projected by the image projection device 18, by changing the mounting angle/position of the image projection device 18 relative to the vehicle compartment ceiling 22.

As shown in FIG. 4, the processing device 20 of the present embodiment is provided with the measuring part 201, the projection range controller 202, and the image controller 203 just like the first embodiment. Further, like the first embodiment, the measuring part 201 performs the three-dimensional measurement, and sets up the display target range, and the projection range controller 202 adjusts the projection range RGpj of the image light to the A-pillar surface 12a, which is the display target range.

However, unlike the first embodiment, the projection range controller 202 of the present embodiment calculates the position difference of the projection range RGpj relative to the display target range. Then, the projection range controller 202 operates the position adjustment mechanism 30, moving/rotating the image projection device 18 against the vehicle compartment ceiling 22, so that the position difference of (i.e., between) the projection range RGpj is eliminated. The projection range RGpj of FIG. 4 is thus adjusted to the A-pillar surface 12a, i.e., to the display target range.

Since the present embodiment adopts the same scheme as the first embodiment, in which the projection range RGpj of the image light is adjusted to the A-pillar surface 12a based on the result of the three-dimensional measurement of the A-pillar 12, the image is easily displayed on the A-pillar surface 12a.

### Other Embodiments

### Modifications of First and Second Embodiments

(1) In each of the above-mentioned embodiments, the projection type image display device 10 is used in order to perform the optical camouflage in a vehicle compartment, but the projection type image display device 10 may be used for the other purposes other than the optical camouflage.

For example, the projection type image display device 10 may display, by projecting the image light, an image about a function or an operation method of an operation switch or the like in the vehicle compartment on or around such operation switch, for guiding the operation of the operation switch by the vehicle occupant. If, for example, the operation switch is an air-conditioner switch, an image showing an operation direction of the air-conditioner switch is displayed on a surface of the air-conditioner switch.

In case that the projection type image display device 10 is not used for the optical camouflage, the camera 16 for imaging the outside view is not required. The projection type image display device 10 may be used in the other environment other than vehicles.

(2) In each of the above-mentioned embodiments, the first light source 181 is comprised of the three laser light sources 181R, 181G, and 181B. However, the first light source 181 may have only one of the three laser light sources 181R, 181G, and 181B.

(3) In each of the above-mentioned embodiments, the measurement light from the second light source 183 is a monochromatic visible light. However, the measurement light may be other than the visible light, and may have other wavelength, since the measurement light may be any light as long as it is usable in the three-dimensional measurement.

(4) In each of the above-mentioned embodiments, the light scanner 187 is provided with, for example, a galvanomirror that serves as an optical polariscope. However, as the optical polariscope, the other device other than the galvanomirror, for example, a polygon mirror, a Micro-Electro Mechanical System (MEMS) scanner, or the like may be provided.

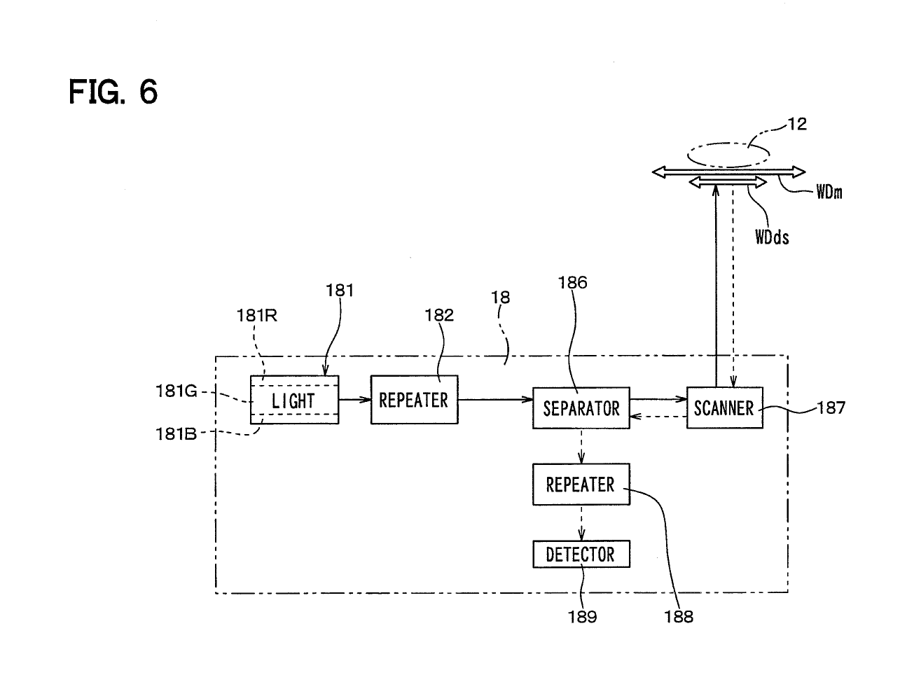

(5) In each of the above-mentioned embodiments, the image projection device 18 is provided with the second light source 183 in addition to the first light source 181, as shown in FIG. 2. However, as shown in FIG. 6, the image projection device 181 may be provided only with the first light source 181 without having the second light source 183, and one of the three laser light sources 181R, 181G, 181B in the first light source 181 may be configured to project the measurement light. In such a configuration, the composer 185 becomes unnecessary.

(6) In each of the above-mentioned embodiments, an entire A-pillar surface 12a is treated as the display target range, since the outline of the A-pillar surface 12a identified in the three-dimensional measurement is set up as the display target range. However, the display target range may also be set up as a part of the A-pillar surface 12a.

(7) In each of the above-mentioned embodiments, the image projection device 18 is a laser projector which projects a laser beam. However, the image projection device 18 may be a projector of other methods, such as a liquid crystal projector, or the like.

(8) In the first above-mentioned embodiment, the target object onto which the image light is projected is the A-pillar 12. However, the target object may be other than the A-pillar 12, i.e., may be a moving object that moves relative to the image projection device 18, for example. When the target object is a moving object, the image display on the moving object may be controlled to follow the movement of the moving object, by performing a real-time three-dimensional measurement and by performing a real-time display target area setting during the image display by the image light.

(9) In each of the above-mentioned embodiments, the processing device 20 is a separate device which is separate from the image projection device 18. However, the image projection device 18 may have the processing device 20 built therein.

(10) According to the above-mentioned first embodiment, the projection type image display device 10 performs the three-dimensional measurement of the A-pillar 12 that is disposed on the driver's seat 11R side by using the image projection device 18, for displaying an image on the A-pillar 12.

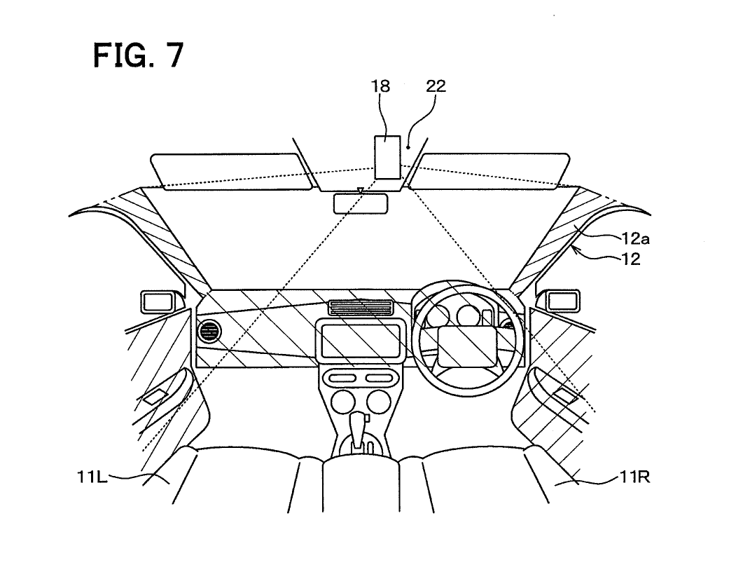

However, as shown in FIG. 7 by hatched portions, the projection type image display device 10 may display an image on the other parts, i.e., on the A-pillar 12 on a passenger seat 11L side, on an instrument panel, on a steering wheel, and on one or more parts of both or either of the two front doors, in addition to the A-pillar 12 on the driver's seat 11R side.

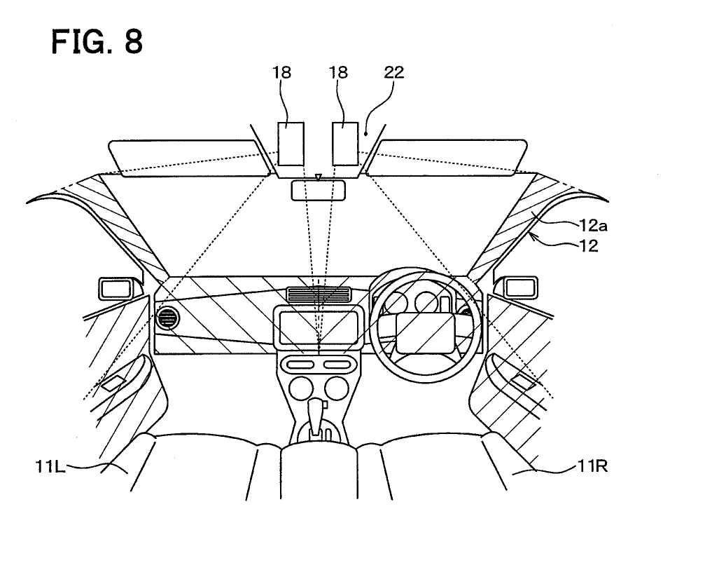

Further, when displaying an image in the same manner on an inside of the vehicle compartment as shown in FIG. 7, two image projection devices 18 may be used as shown in FIG. 8. In such case, for the right half of the compartment, one of the two image projection devices 18 disposed on the right side may perform the three-dimensional measurement and display the image by projecting the image light, and, for the left half of the compartment, the other one of the two image projection devices 18 may perform the three-dimensional measurement and display the image by projecting the image light. Further, in such case, the image displayed by the image projection device 18 on one side and the image displayed by the image projection device 18 on the other side do not need to constitute a continuously-connected single image. That is, for example, while displaying an image including information for the driver on the right side, i.e., on the driver's seat 11R side, another image including information for a passenger seat occupant may be displayed on the left side, i.e., on the passenger seat 11R side, without regard to the driver's seat 11R side.

(11) In the above-mentioned second embodiment, the position adjustment mechanism 30 is provided with a device to move and rotate the mechanism 30 against the vehicle compartment ceiling 22. However, the mechanism 30 may additionally have a device, i.e., a fine-tuning mechanism that performs a fine-tuning of the projection range RGpj of the image light by shifting a lens, or the like, which constitute the optical system in the image projection device 18.

### Third Embodiment

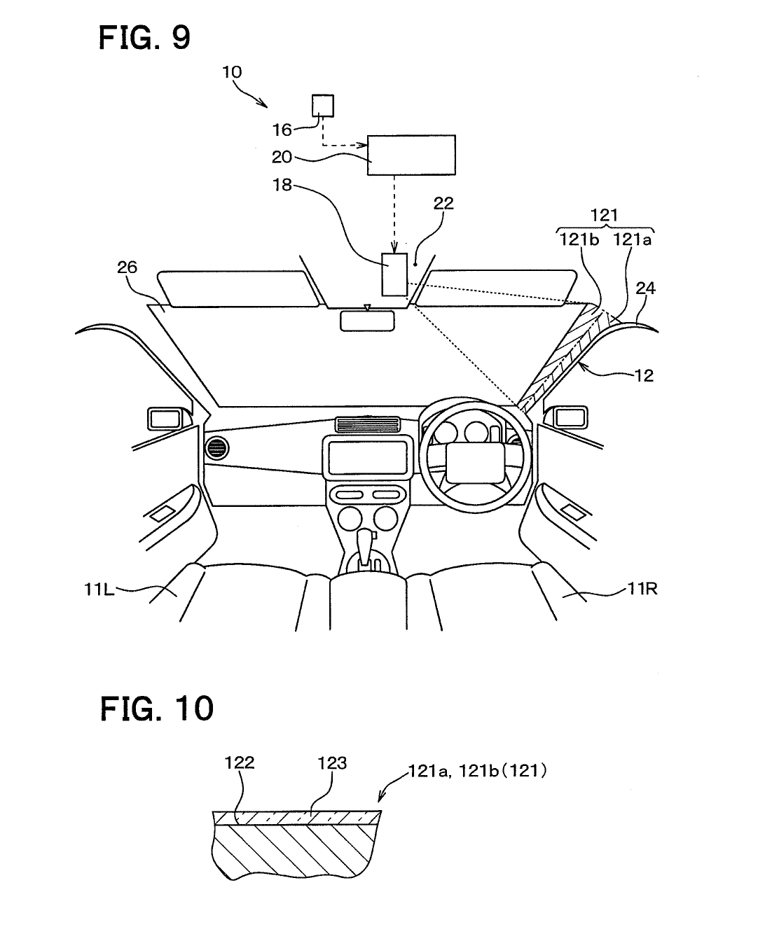

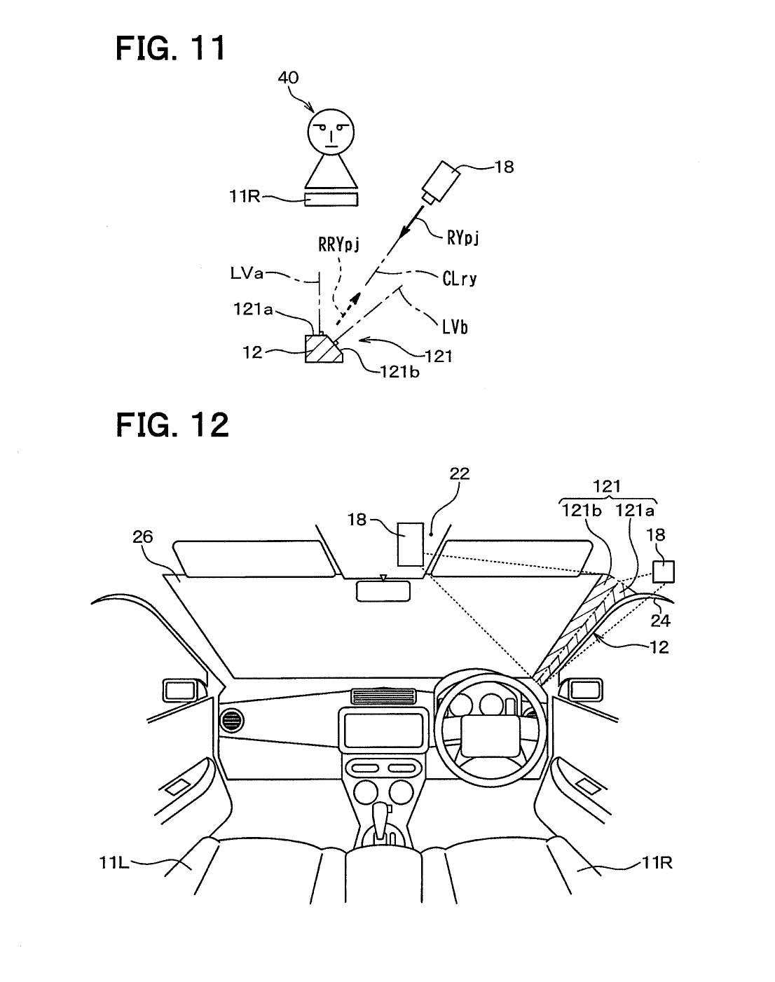

FIG. 9 shows an outline configuration of a projection type image display device 10 concerning the present disclosure, together with a front view from an inside of a vehicle compartment. The projection type image display device 10 is a display device for vehicles, and it is used, for example, to provide an optical camouflage effect for a wall, i.e., for an inner surface, of the vehicle compartment. More specifically, the projection type image display device 10 may be used to optically eliminate or diminish a dead angle in a view of a driver 40 (see FIG. 11), which is caused by an A-pillar 12 disposed on a driver's side of a windshield (i.e., on a driver's seat 11R side), by projecting an outside view image onto an inside surface 121 of the A-pillar 12, i.e., onto an A-pillar surface 121. The A-pillar surface is an image display surface in the claims of the present disclosure. Further, the driver 40 is a vehicle occupant sitting on a driver's seat 11R, and is a viewer of an image that is displayed on the A-pillar surface 121. Further, the driver's seat 11R comprises, for example, a seat surface part which constitutes a seat surface on which the driver 40 sits down, a back support part which supports a back of the driver 40, and a headrest part which prevents a backward tilting of a head of the driver 40.

The projection type image display device 10 includes, as shown in FIG. 9, a camera 16 for imaging an outside view of the vehicle, which is a dead angle image hidden from a view of the driver 40 by the A-pillar 12 (FIG. 11) and an image projection device 18 that serves as a projector which projects an image light RYpj (see FIG. 11) on the A-pillar surface 121, and a processing device 20 which is an electrical control unit disposed at a position which is not visible from a vehicle occupant.

The camera 16 for imaging an outside view is a CCD camera 16 for imaging the outside view is disposed so that the outside view from the camera 16 is substantially the same as the view of the driver who is sitting on the driver's seat 11R, i.e., including a dead angle image of the outside view behind the A-pillar 12. The camera 16 for imaging the outside view is attached on an outside of the vehicle in proximity of the A-pillar 12.

The image projection device 18 is a laser projector which projects a laser beam and displays an image. A projection direction of the laser beam from the image projection device 18 points to the A-pillar 12, for example, that is, the image projection device 18 is so disposed at a forward center position of a ceiling 22 of the vehicle compartment.

More concretely, the image projection device 18 projects the laser beam as the image light RYpj (see FIG. 11), to display an image captured by the camera 16 on the A-pillar surface 121. That is, the dead angle image, i.e., the outside view, behind the A-pillar 12 in a view of the driver 40 who is sitting on the driver's seat 11R is captured by the camera 16 at predetermined intervals or continuously, and the image projection device 18 displays the dead angle image on the A-pillar surface 121 by projecting the image light RYpj.

The A-pillar 12 is positioned between a driver's side door 24 on one side of the driver's seat 11R and a windshield 26. The A-pillar surface 121 disposed on an inside, i.e., on a vehicle compartment side, of the A-pillar 12 is the image display surface on which an image is displayed by a reflection of the image light RYpj (see FIG. 11), and the A-pillar surface is provided with both of two characteristics, i.e., a retro-reflective characteristic and a diffuse-reflective characteristic.

The reflection characteristics of such surface 121 described above may be constituted, for example, as shown in a sectional view in FIG. 10, by making the A-pillar surface 121 as a diffuse-reflective surface 122 having a diffuse-reflective characteristic, on which a thin film layer of retro-reflective material 123 having a retro-reflective characteristic is coated, which may be made of glass beads or the like. In such configuration, the greater the thickness of the retro-reflective material 123 layer is, or, the larger the amount of coating of the retro-reflective material 123 per unit area is, the greater the ratio of the retro-reflective component becomes in the reflected light from the surface 121, and, at the same time, the smaller the ratio of the diffuse-reflective component light becomes in the reflected.

The A-pillar surface 121 is described with reference to FIGS. 9 and 11. FIG. 11 is an illustration of a positional relationship between the driver 40, the image projection device 18, and the A-pillar surface 121.

As shown in FIGS. 9 and 11, the A-pillar surface 121 has a first area 121a on the driver's side door 24 side, and has a second area 121b on a windshield 26 side. Further, a normal line LVa, which may also be designated as a normal line direction LVa of the first area 121a, differs from a normal line LVb, which may also be designated as a normal line direction LVb of the second area 121b.

In more detail, the normal line LVa of the first area 121a points in a direction that is closer to the driver's seat 11R (see FIG. 9) than the normal line LVb of the second area 121b. In other words, an angle between a pointing direction of the normal line LVa of the first area 121a and an imaginary line extending between the first area 121a and the driver's seat 11R is less than an angle between a pointing direction of the normal line LVb of the second area 121b and an imaginary line extending between the second area 121b and the driver's seat 11R. Such a relationship between the first area 121a and the second area 121b is valid for any part of the entirety of the first area 121a and any part of the entirety of the second area 121b. Further, such a relationship between the first area 121a and the second area 121b is valid for whatever position the driver's seat 11R is adjusted to within a movable range. In short, any part of the first area 121a is an area that faces the driver 40 sitting on the driver's seat 11R more normally than any part of the second area 121b. Further, even though the first area 121a and the second area 121b are respectively a part of the surface 121 that is one curved surface, the first area 121a and the second area 121b are illustrated as two separate planes as shown in FIG. 3, for the ease of understanding.

Further, in the first area 121a on the A-pillar surface 121, the amount of the retro-reflective material 123 per unit area is greater than the second area 121b. Thereby, when a reflection of an incident light, i.e., the image light RYpj reflected on the A-pillar surface 121, comes back toward the driver as the reflected light, the first area 121a is made to reflect a “retro-reflective component rich light”, in which a ratio of the retro-reflected component of the reflected light from the first area 121a is configured to be greater than a ratio of the same component of the reflected light from the second area 121b, and a ratio of the diffusive component of the reflected light from the first area 121a is configured to be smaller than a ratio of the same component of the reflected light from the second area 121b.

Further, as shown in FIG. 11, the image projection device 18 is arranged so that the image light RYpj is uniformly projected onto the entire A-pillar surface 121 for displaying an image. For example, the image projection device 18 is arranged so that a retro-reflective component of each of the reflected lights of the image light reflected in the first area 121a and the second area 121b is directed away from the driver's seat 11R. Since the image projection device 18 is disposed on a forward center position of the vehicle compartment ceiling 22 in FIG. 9, the retro-reflective component goes back to the forward center position of the vehicle compartment ceiling 22. In short, since the retro-reflective component of the above-described reflected light travels along an optical axis CLry of the image projection device 18 from the first area 121a and from the second area 121b, the retro-reflective component goes to a position that is different from the driver's seat 11R without going to the driver's seat 11R. This description of the reflection scheme is valid for whatever position the driver's seat 11R is adjusted to within the movable range. That is, in other words, the retro-reflective component of the reflected light will not reach the eyes of the driver 40 who is sitting on the driver's seat 11R. In FIG. 11, the retro-reflective component of the reflected light is represented by a dashed-line arrow RRYpj.

Returning to FIG. 9, the processing device 20 is an electrical control unit which is comprised of a microcomputer and a peripheral circuit which are well-known in the art, which may consist of CPU, ROM, RAM, etc. The processing device 20 performs various control processes according to a computer program memorized in advance in the ROM or the like.

As shown in FIG. 9, a video signal etc. with which image information of the camera 16 for imaging the outside view is conveyed, for example, is inputted to the processing device 20. From the processing device 20, a video control signal etc. which controls the image light RYpj projected by the image projection device 18, for example, are outputted to the image projection device 18.

The processing device 20 displays an image on the A-pillar surface 121 by projecting the image light RYpj toward the A-pillar 12, based on the input and the output of such signal.

In the present embodiment, since the normal line LVa of the first area 121a points closer to the driver's seat 11R as compared with the normal line LVb of the second area 121b regarding the surface/reflection scheme of the A-pillar surface 121, the first area 121a faces the driver 40 on the driver's seat 11R more normally (i.e., more “face-to-face”, or more straight-facing) than the second area 121b. Therefore, if each of the first area 121a and the second area 121b reflects the image light only diffusively without reflecting the image light in a retro-reflective manner, the image displayed on the first area 121a appears brighter than the image on the second area 121b for the driver 40.

On the other hand, according to the present embodiment, the image projection device 18 is so arranged that a retro-reflective component of the reflected light, among other components, is directed away from the driver's seat 11R (i.e., the retro-reflective component will not come into the driver's eye). Therefore, when the image light is reflected respectively by the first area 121a and the second area 121b, the driver 40 mainly sees the diffusive component of 11R (i.e., the retro-reflective component will not come into the driver's eye). Therefore, when the image light is reflected respectively by the first area 121a and the second area 121b, the driver 40 mainly sees the diffusive component of the reflected image light in his/her view. Further, the image light from the first area 121a has a greater retro-reflective component ratio than the image light from the second area 121b, while the image light from the first area 121a has a smaller diffusive component ratio than the image light from the second area 121b.

Therefore, unevenness of the image brightness among the first area 121a and the second area 121b becomes less recognizable. Therefore, unevenness or speckle of the image brightness is prevented in the view of the driver 40, among the image on the first area 121a and the image on the second area.

### Other Embodiments

(1) In the above-described embodiment, the projection type image display device 10 is used to provide an optical camouflage effect for a vehicle compartment, but the projection type image display device 10 may be used for providing other effects other than the optical camouflage effect.

For example, the projection type image display device 10 may display a guidance image which provides a visual guidance of a function and/or an operation method of an operation unit that is operated by a vehicle occupant, by projecting the image light RYpj in the vehicle compartment onto the operation unit itself or at a proximate position of the operation unit. If, for example, the operation unit is an air-conditioning switch, a guidance image showing an operation direction of the air-conditioning switch is displayed on a surface of the air-conditioning switch.

In case that the projection type image display device 10 is not used for the optical camouflage, the camera 16 for imaging the outside view is not required. The projection type image display device 10 may be used in the other environment other than vehicles.

(2) In the above-described embodiment, one image projection device 18 is used to project the image light RYpj on the entire A-pillar surface 121, i.e., on both of the first area 121a and the second area 121b. However, as shown in

FIG. 12, the projection type image display device 10 may have two image projection devices 18, among which the first image projection device 18 may project the image light RYpj on the first area 121a and the second image projection device 18 may project the image light RYpj on the second area 121b. In FIG. 12, the first image projection device 18 is positioned on a driver's seat 11R side of the vehicle compartment ceiling 22, and the second the image projection device 18 is positioned on a forward center position of the vehicle compartment ceiling 22, just like the illustration in FIG. 9, for example.

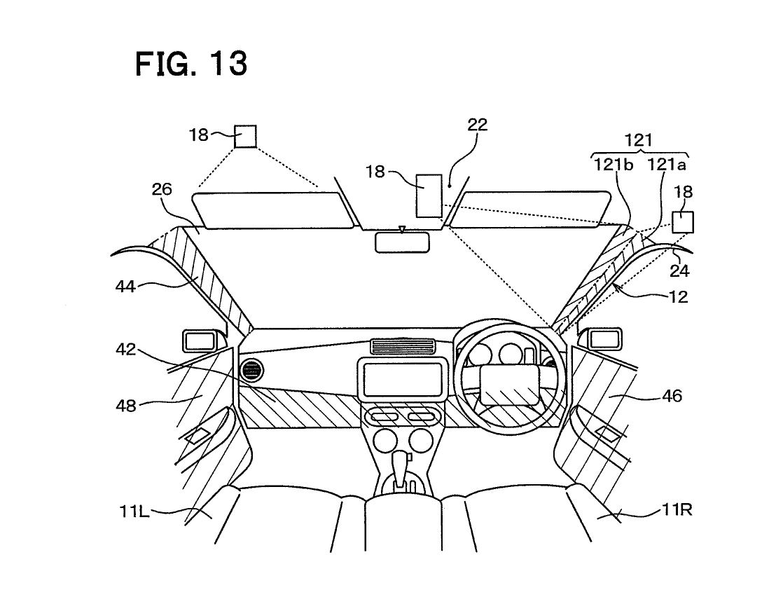

As another example, as shown in FIG. 13, the projection type image display device 10 may even have the third image projection device 18, in addition to the first and second image projection devices 18. The third image projection device 18 may project the image light RYpj on any one or more of a lower part 42 of a dashboard, a compartment side A-pillar surface 44 of an A-pillar on a passenger seat 11L side, a compartment side surface 46 of a door on a driver's seat 11R side, and a compartment side surface 48 of a door on a passenger seat 11L side, for example. In such manner, the third image projection device 18 displays a dead angle image which is an outside view hidden from the driver 40 by one or more of the parts described above, for diminishing the dead angle caused by one or more of those parts.

(3) In the above-described embodiment, the image projection device 18 is a laser projector which projects a laser beam. However, the image projection device 18 may be a projector of other methods, such as a liquid crystal projector, or the like.

(4) In the above-described embodiment, the processing device 20 is a separate device which is separate from the image projection device 18. However, the image projection device 18 may have the processing device 20 built therein.

(5) In the above-described embodiment, the A-pillar surface 121 has the first area 121a and the second area 121b. However, the A-pillar surface 121 has other surfaces for the display of an image, other than the first area 121a and the second area 121b.

Although the present disclosure has been fully described in connection with preferred embodiment thereof with reference to the accompanying drawings, it is to be noted that various changes and modifications will become apparent to those skilled in the art, and such changes, modifications, and summarized scheme are to be understood as being within the scope of the present disclosure as defined by appended claims.

In each of the above-described embodiments, the components in those embodiments may be not necessarily an indispensable one, except for the case in which it is explicitly described as necessary or except for the case in which it is absolutely necessary in pertaining principles. Further, in each of the above-described embodiments, regarding the number, i.e., the number of those components, as well as the value, the amount, the range and the like, the number is not limited to a specific one mentioned in the embodiments, except for the case in which it is explicitly described as limited to such number or except for the case in which it is absolutely necessary to have such number based on pertaining principles. Furthermore, in each of the above-described embodiments, the material, the shape, the positional relationship and the like are not limited to a specific one mentioned in the embodiments, except for the case in which it is explicitly described as limited to such material/shape/positional relationship or except for the case in which it is absolutely necessary to have such material/shape/positional relationship based on pertaining principles.

What is claimed is:

1. A projection type image display device comprising:
an image projection device projecting a measurement light onto a target object to provide a three-dimensional measurement of the target object and projecting an image light onto an object surface of the target object to display an image onto the object surface;
a measuring part performing the three-dimensional measurement of the target object by using the measurement light; and
a projection range controller controlling a projection range of the image light to match the projection range with the object surface based on a result of the three-dimensional measurement.

2. The projection type image display device of claim 1, wherein
the image projection device projects the measurement light and the image light from a same light source.

3. The projection type image display device of claim 1, further comprising:
a first light source serving as a light source of the image light, and
a second light source serving as a light source of the measurement light.

4. The projection type image display device of claim 1, wherein
a dead angle image is defined as an outside view of a vehicle in a dead angle behind a front pillar relative to a driver sitting in a driver's seat, a front pillar surface is a vehicle compartment side surface of the front pillar that serves as the target object, and the image projection device displays the dead angle image on the front pillar surface by projecting the image light.

5. The projection type image display device of claim 1, wherein
the image projection device includes
a first image projection device that projects the image light onto a region positioned on a driver's seat side in a vehicle compartment, and
a second image projection device that projects the image light onto a region positioned on a passenger seat side in the vehicle compartment.

6. The projection type image display device of claim 1, further comprising:
a position adjustment mechanism changing the projection direction of the image light by adjusting a mounting position of the image projection device, wherein
the image projection device projects the image light at the projection range which is predefined relative to the image projection device, and
the projection range controller adjusts the projection range to the object surface by operating the position adjustment mechanism so that a position difference between the projection range and the object surface is eliminated.

7. The projection type image display device of claim 1, wherein
the image projection device is a laser projector that projects a laser beam as the image light and as the measurement light, and
a measurement range is a scan range for the three-dimensional measurement, an imaging scan range is a scan range for displaying the image, and the projection range controller adjusts the projection range to the object surface by narrowing down the measurement range to the imaging scan range.

8. A projection type image display device comprising:
an image projection device projecting an image light; and
an image display surface disposed on a vehicle compartment side of a front pillar on a driver's seat side of a windshield and displaying an image by reflecting the image light,
the image display surface including a first area and a second area each having normal lines pointing in different directions, the first area reflecting the image light both in a retro-reflective manner and in a diffusive manner and the second area reflecting the image light in the diffusive manner, wherein
a normal line of the first area points in a direction that is closer to a driver's seat than does a normal line of the second area,
a ratio of a retro-reflective component in the reflected image light from the first area is greater than a ratio of a retro-reflective component in the reflected image light from the second area,
a ratio of a diffusive component of the reflected image light from the first area is smaller than a ratio of a diffusive component of the reflected image light from the second area, and
the image projection device controls the retro-reflective components in the reflected image light from the first and second areas to direct the retro-reflective components away from the driver's seat.

9. The projection type image display device of claim 8, wherein
the image projection device displays, by projecting the image light onto the image display surface, a dead angle image that is an outside view of the vehicle that is hidden from a driver on a driver's seat by the front pillar.

10. The projection type image display device of claim 8, wherein
the image projection device is disposed at a forward center position on a vehicle compartment ceiling and projects the image light onto the image display surface.

11. The projection type image display device of claim 8, wherein
the front pillar is disposed at a position between a driver's side door that is on one side of the driver's seat and a windshield, and
the first area of the image display surface is positioned on a driver's side door side of the front pillar and the second area of the image display surface is positioned on a windshield side of the front pillar.

12. The projection type image display device of claim 8, wherein
the first area has a diffuse-reflective surface reflective in a diffusive manner and a retro-reflective material that is coated on the diffuse-reflective surface as a thin-film layer, and
the reflected image light from the first area includes a greater ratio of the retro-reflective component than the reflected image light from the second area, according to an amount of coating of the retro-reflective material per unit area being increased in the first area than the second area.
